(19) United States
(12) Patent Application Publication
(10) Pub. No.: US 2013/0085117 A1
(43) Pub. Date: Apr. 4, 2013

(54) Compositions Comprising Plant Material and Sugar For The Control of Pests and Methods of Making

(71) Applicant: MPT MUSTARD PRODUCTS & TECHNOLOGIES, Saskatoon (CA)

(72) Inventor: NEIL WAGNER, Hague (CA)

(73) Assignee: MPT MUSTARD PRODUCTS & TECHNOLOGIES INC., Saskatoon (CA)

(21) Appl. No.: 13/627,237

(22) Filed: Sep. 26, 2012

Related U.S. Application Data
(63) Continuation of application No. PCT/CA2011/000308, filed on Mar. 25, 2011.
(60) Provisional application No. 61/317,934, filed on Mar. 26, 2010.

(51) Int. Cl. A01N 43/16

(52) U.S. Cl. CPC A01N 43/16
USPC 514/53; 514/23

(57) ABSTRACT

Compositions and methods for controlling pests are described. The compositions comprise (a) a material obtainable from a plant comprising an effective amount of a glucosinolate breakdown product and (b) a sugar. The novel compositions exhibit improved properties over known formulations, for example with respect to their potency, ease of manufacture and ease of application.

### RELATED APPLICATIONS

This application is a continuation of International Application No. PCT/CA2011/000308 filed Mar. 25, 2011 (which designated the U.S.) which claims the benefit of U.S. provisional application Ser. No. 61/317,934 filed Mar. 26, 2010 (now abandoned). All of the prior applications are incorporated herein by reference in their entirety.

### FIELD OF THE DISCLOSURE

The disclosure described herein relates to compositions comprising plant material, notably mustard plant material, comprising glucosinolates and methodologies for making them. These compositions, further comprising a sugar, are useful for the treatment of pests.

### BACKGROUND OF THE DISCLOSURE

Pesticides are used to control pests in areas such as crops, homes, and food storage areas. However the large scale use of pesticides particularly in the second half of the twentieth century and early twenty first century has resulted in significant concerns with respect to the environmental impact, increased resistance against pesticides in the pest populations, as well as toxicity to non-target organisms, including humans. Controversial is for example the use of polychlorinated hydrocarbons, such as DDT, as they persist for extended periods of time in the environment and are harmful for example to fish and birds of prey. Another class of pesticides, methylbromides, in addition to being toxic to the human nervous and respiratory system, poses damage to the stratospheric ozone layer, as a result of which governments in many jurisdictions have been severely restricting the use of methylbromides. Other widely used efficacious pesticides include organophosphates and carbamates, and while these compounds decompose more rapidly in the environment, they are still considered highly toxic.

One alternative is the use of pesticides obtainable from natural sources, also referred to in the art as biopesticides. These biopesticides are prepared from sources such as plants which frequently comprise natural defenses against insects and other pests. Glucosinolates which are ubiquitously found within the mustard plant family (also alternatively known to the art as “Cruciferae” or Brassicaceae”), which includes for example, mustard and rapeseed, act as pesticides in many plants. The pesticidal efficacy of mustard plant material is attributable to glucosinolate breakdown products, including allyl thiocyanate and allyl isothiocyanate, rather than glucosinolates themselves. These glucosinolate degradation products are formed following an enzymatic reaction involving enzymes endogenously present in mustard plant material.

Pesticide products based on mustard plant material are known to the prior art. US Patent Application 2008/0182751, for example, discloses the use of mustard plant material to control plant pests, including insects, and U.S. Pat. No. 5,717,056 teaches the use of mustard bran to control soil pests. The use of mustard meal to control plant pests is disclosed in Brown, J. and Morra, M. J, 2005, Subcontract Report National Renewable Energy Laboratory NREL/SR-510-35254. Purified products and organic extracts obtainable form mustard plants for use of the treatment of pests are also known to the prior art. In this regard U.S. Pat. No. 7,087,553 discloses a process for eliminating unwanted organisms in agriculture comprising the co-application of mustard oil in water and a solution of phosphorus in water. U.S. Pat. No. 6,545,043 teaches methods for suppressing target pests using a composition comprising a purified glucosinolate breakdown product obtainable from mustard plants. Mustard meal based glucosinolate products have been demonstrated to exhibit inhibitory effects against arthropods, as well as weeds, fungi and bacteria (see: Brown, J. and Morra, M. J, 2005, Subcontract Report National Renewable Energy Laboratory NREL/SR-510-35254).

Notwithstanding the foregoing there are significant problems associated with the use of mustard plant material, and in particular mustard seed based material, such as seed meal, as a pesticide that limit widespread use and acceptance of mustard plant material as a pesticide. Firstly, mustard seed derived material, does not dissolve readily into water due to the presence of the seed oil. As a result the preparation of mustard meal into a commercially acceptable pesticide and fertilizer formulation poses challenges resulting, for example, in formulations which leave undesirable residue on the surface when applied. Secondly, when pressing mustard meal it is difficult to formulate the pressed meal into a commercially applicable product due to its powder-like constitution. Powder is light and therefore challenging to formulate, difficult to apply to target areas and subject to being blown around in the wind. Thirdly, when pressing mustard meal into a commercially acceptable product it is difficult to control the granular size of the product. Control over the granular size is desirable as it permits control of the enzymatic reaction yielding the pesticidal compounds and improved applicability to the surface area. Fourthly, it is important that the mustard seed enzymes responsible for the formation of the pesticidal compounds come into contact with their substrate, i.e. the glucosinolates. Frequently in the preparation of mustard plant material based pesticides, the mustard seed enzymes remain partly isolated from their substrate resulting in a product that does not fully react, and therefore is less potent and effective. Fifthly, a requisite reagent for the enzymatic reaction is water, however the mustard meal's lipophilic properties result in a suboptimal reaction, reducing the product's potency.

In summary, there still are significant shortcomings with mustard plant material based formulations capable of controlling pests that are known to the prior art. In particular, there is a need for an efficacious, easy to formulate and easy to apply pesticide prepared from mustard plant material.

### SUMMARY OF THE DISCLOSURE

The present disclosure provides novel formulations comprising a glucosinolate containing plant material that are useful in the treatment of pests. The formulations herein disclosed are superior to the heretofore known glucosinolate plant material based formulations in many respects, including with respect to their potency, ease of manufacture and ease of application.

Accordingly, the present disclosure provides a composition for controlling pests comprising: (a) a material obtainable from a plant and comprising an effective amount of a glucosinolate breakdown product and (b) a sugar.

In preferred embodiments of the present disclosure the material obtainable from a plant is obtainable from a mustard plant. In particularly preferred embodiments the mustard plant material is a mustard seed meal.

The present disclosure further provides methods for preparing a pesticide composition comprising providing a material obtainable from a plant comprising an effective amount of a glucosinolate breakdown product and mixing the material obtained from mustard plants with a sugar.

The present disclosure also provides a method for controlling pests comprising applying to a pest a composition comprising (a) a material obtainable from a plant and comprising an effective amount of a glucosinolate breakdown product and (b) a sugar.

The present disclosure still further provides a method for controlling pests comprising (a) preparing a composition comprising:
(i) a material obtainable from a plant and comprising an effective amount of a glucosinolate breakdown product; and
(ii) mixing the material obtained from plants with a sugar; and

(b) applying the composition to a pest.

Other features and advantages of the present disclosure will become apparent form the following detailed description. It should be understood, however, that the detailed description and the specific examples, while indicating preferred embodiments of the disclosure, are given by way of illustration only, since various changes and modifications within the spirit and scope of the disclosure will become apparent to those of skill in the art from the detailed description.

### BRIEF DESCRIPTION OF THE DRAWINGS AND TABLES

FIG. 1 depicts the inhibition of R. solani mycelial growth three days after exposure to vapour from various concentrations of Oriental mustard meal and Oriental meal+sugar, as a percentage of a water control.

FIG. 2 depicts the mean Radial growth of R. solani mycelium over time under exposure to different concentrations of Oriental mustard meal+sucrose.

FIG. 3 depicts the mean radial growth of R. solani mycelium over time under exposure to vapour from different concentrations of Oriental mustard meal.

### DETAILED DESCRIPTION OF THE DISCLOSURE

As hereinbefore mentioned, the present disclosure relates to novel compositions comprising plant material for use in the control of pests. The present inventor has found that plant material comprising glucosinolates when formulated with a sugar results in a composition exhibiting superior pesticide characteristics. In particular, the compositions provided herein, surprisingly, permit control over the enzymatic reaction responsible for the conversion of glucosinolates into pesticidally active products, thus allowing for the preparation of compositions with a wide range of varying potencies. In addition, the potencies that may be achieved using the compositions of the present disclosures exceed the potencies of plant material based compositions known to the prior art. Furthermore the formulations herein provided are prepared in a manner that permits the preparation of compositions with a variety of granular sizes, thus allowing for the preparation of pesticide formulations other than powder based formulations. The compositions prepared in accordance with the present disclosure also break down more readily than conventional plant material based formulations, resulting in a reduction or elimination of the amount of residue left on the surface to which the pesticide product is applied. Finally, the compositions provided herein are additionally beneficial in that they are natural, organic and biodegradable.

Accordingly the present disclosure provides a composition for controlling pests comprising: (a) a material obtainable or obtained from a plant and comprising an effective amount of a glucosinolate breakdown product and (b) a sugar.

In preferred embodiments the plant that is used in accordance with the present disclosure is a mustard plant. The term “mustard plant” and “mustard family” as used herein denotes any plant belonging to the family of Brassicaceae, including any plant belonging to the genera Brassica and Sinapis. Representative examples of mustard plants that may be used in accordance with the present disclosure include Brassica napus (rapeseed), Brassica juncaea (Indian, Oriental or brown mustard), Brassica carinata (Abyssinian or Ethiopian mustard), Brassica nigra (black mustard), Brassica rapa (rapeseed), Sinapis alba (white mustard), Sinapis arvensis (wild mustard), and any cultivars of the foregoing including the Canola cultivar of Brassica napus.

The term “glucosinolate breakdown product” refers to products obtainable following hydrolysis of glucosinolate. The general structure of glucosinolate is:

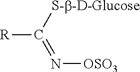

Examples of glucosinates that may be found in the plant material used in accordance with the present disclosure are epiprogoitrin, sinigrin and sinalbin. Included within the term glucosinolate breakdown products are the following three general classes of glucosinolate breakdown products:

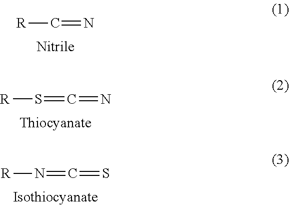

Further glucosinolate breakdown products include 1-cyano-2-hydroxy-3-butene (“CHB”) and goitrin, which are obtained following the breakdown of the glucosinolate epiprogoitrin. Further glucosinolate breakdown products include allyl thiocyanate (“ATC”), allyl isothiocyanate (“AITC”) and allyl cyanide (“AC”) all of which are breakdown products of the glucosinolate sinigrin. Still further glucosinolate breakdown products include hydroxyl benzols.

### Plant Material

In accordance with the present disclosure any plant material comprising glucosinolates may be used, including any processed plant material, obtainable from the leaves, stems, roots or seeds of plants. Preferably the plant material as used herein is treated such as to produce a processed plant material. The plant material may for example be crushed or pressed to obtain a crushed or pressed plant material. Preferably the plant material or processed plant material used in accordance herewith is moistened using water and homogenized in order to promote the hydrolysis of glucosinolates. Pre-treatment of the plant material is preferred for certain plant materials, such as seed. Pre-treatment processes that may be used in accordance herewith include dehulling, cracking, grinding, flaking, pressing, extruding, pelleting and the like. When oil rich plant material is used in accordance herewith, it is preferable to remove the oil from the plant material. This may be accomplished through methods such as solvent extraction, hydraulic pressing, expeller pressing, cold pressing and other oil removal processes that will be well known to the skilled artisan. Since the hydrolysis of glucosinolates is performed by the heat labile enzyme plant enzyme myrosinase it is preferred that all pre-treatment steps are performed at temperatures below 60° C., more preferably below 50° C. and most preferably below 35° C.

In a preferred embodiment of the present disclosure, the processed plant material used is a mustard seed meal. Many processes for processing raw mustard seed into oil and meal known to the art. Illustrative processes are those taught by and Morra, M. J, 2000-2002, Subcontract Report National Renewable Energy Laboratory NREL/SR-510-3628. Typical of these processes is the receipt of mustard seed from the field by conventional transport means, for example, rail or truck, in a dirty and often wet condition. The mustard seed is then subjected to an elementary separation procedure, for example, contacted with a vibrating screen or using a grain cleaning machine, for example a grain cleaning machines manufactured by Damas A/S (Denmark), in which the mustard seed is separated from non-mustard seed material, such as rocks, sticks, dirt, leaves, weed seeds, loose hulls etc. It is preferred that following the cleaning the mustard seed is dried, using for example a grain dryer as manufactured by Vertec Industries Limited (Canada), so that the moisture content of the seed is reduced to between 5% and 7%. Following the removal of non-mustard seed contaminants and drying the mustard seed may be stored, mixed with other mustard seed, or processed to obtain mustard seed meal. At this point in the process the outer seed coating, which is also known as the seed husk or bran, may be removed from the seed by milling or cracking the seed or using another suitable abrasive process to obtain the seed kernel. Such removal of the bran is however optional and not of critical importance. The next step in the process is largely dependent on the oil (also known as “lipid” or “fat”) content of the mustard meal that is desired. If a “full fat” meal is desired than the kernels are subjected to a process that does not result in oil extraction. If, on the other hand a “defatted” meal is desired than the kernels are subjected to a process resulting in oil extraction. In preferred embodiments of the present disclosure a defatted meal is prepared. Accordingly the mustard seed or mustard kernel (in instances where the bran has been removed) is preferably ground, using for example a hammer mill, to obtain mustard flour. Thereafter the oil is removed from the flour by for example chemical extraction, using for example hexane, or mechanical extraction using for example an oil expeller or press, such as an oil press such as a Täby Press manufactured by Skeppsta Maskin AB (Sweden) or a Komet oil expeller manufactured by Monforts Oekotec GmbH (Germany). Preferably the mustard seed meal used in accordance with the present disclosure comprises between 2% and 50% of the available seed oil, and more preferably approximately between 10 and 15%, and most preferably 15% of the available seed oil. In preferred embodiments of the present disclosure, the mustard seed meal obtained at this point in the process is ready for use as an ingredient for formulation with the sugar and other optional ingredients referred to in this application. It is also noted that at this point in the process seed meals from one or more different sources may be mixed, for example Sinapis alba meal may be mixed with Brassica juncea meal and in this way a blended meal may be obtained, such a blended meal may exhibit different pesticide characteristics, for example it has been observed by the present inventor that a blend of Sinapis alba meal and Brassica juncea meal is particularly useful when a fast release formula is desired.

### Sugar

In accordance with the present disclosure any sugar may be used, including any monosaccharide, disaccharide, trisaccharide, oligosaccharide or polysaccharide. Monosaccharides that may be used in accordance with the present disclosure include any tretrose, pentose, hexose or heptose. Tetroses that may be used include erythose and threose. Pentoses that may be used include arabinose, ribose, ribulose, xylose, xylulose and lyxose. Hexoses that may be used in accordance with the present disclosure include allose, altrose, fructose, galactose, glucose (dextrose), glulose, idose, mannose, sorbose, talose, and tagatose. Heptoses that may be use include seduheptulose. Disaccharides that may be used in accordance with the present disclosure include sucrose, maltose, trehalose, lactose and melibiose. Trisaccharides that may be used include raffinose. Polysaccharides that may be used e.g. glycogen, starch, dextran. Any of the foregoing sugars may be used in more or less pure form. In addition mixtures of sugars may be used in accordance with the present disclosure. In preferred embodiments of the present disclosure the sugar that is used is a disaccharide or a monosaccharide. In particularly preferred embodiments the disaccharide sucrose or lactose is used, or the monosaccarides, fructose and glucose.

### Preparation of Pesticide Formulations

In accordance with the present disclosure the mustard plant material or processed plant material is mixed with an exogenous sugar. The mixing ratio of plant material or processed plant material with the exogenous sugar may vary and by varying the mixing ratio of mustard plant material and the sugar the granular size of the final pesticide formulation may be controlled. Preferably, when using mustard meal, mustard meal is mixed with sugar in concentrations varying from 0.1% w/w to 10% w/w. In preferred embodiments the sugars are mixed with the mustard meal in concentrations varying from 0.5% and 8% w/w. The sugar and mustard plant material are preferably thoroughly mixed in such a manner that a homogenous mixture is obtained using for example a ribbon blender (e.g. a ribbon blender manufactured by Munson Machinery Co (USA)). It is further preferred that the mustard plant material and the sugar are mixed in the presence of water. The amount of water that is used may vary but preferably ranges from 8% w/v to 4% w/v. Mixing of the mustard plant material or processed mustard plant material and sugar may conveniently be performed at ambient temperatures. The seed meal-sugar mixture thereafter is preferably further treated using milling, grinding or pelletizing devices, such as a CPM pellet mill manufactured by CPM (USA), to obtain pellets with a preferred size between 2 mm and 6 mm. Thereafter the pellets may be treated by a device capable of crumbling the pellets, using for example a roll crumbler, such as manufactured by Apollo (USA) and separated for granular size using one or more screening devices comprising gauges which permit the separation of the crumbled pellets into fractions of various sizes, which may be vibrating or rotating screens. Using a rotary screen separator, for example such as manufactured by Peacock Industries (Canada), comprising multiple screens with different of gauges it is possible to obtain products with a range of different granular sizes. Thus the present disclosure permits the preparation of formulations comprising mustard plant material, including mustard meal, and a sugar wherein the granular size of the formulation can be readily controlled and be set as desired. Preferably granular size in formulations prepared in accordance with the present disclosure ranges between 0.01 mm and 10 mm. The concentrations of glucosinolates in the final formulated product may vary but typically ranges between 95 and 225 μmoles/gram. The concentration glucosinolate breakdown product present in the formulations prepared in accordance with the present disclosure also may vary. Typically AITC is present in the final formulation in concentrations of at least 10 moles/gram and more preferably between 10 and 200 μmoles/gram and most preferably between 10 and 90 μmoles/gram. Within the foregoing concentration ranges the glucosinolate breakdown products of the present disclosure are effective in that they provide for a reduction or limitation of the incidence or severity of the pest infestation or activity for a limited or more prolonged period of time.

The pesticide formulations prepared in accordance with the present disclosure further preferably comprises a carrier. The term “carrier” as used herein refers to the means by which the pesticide is delivered to the target pest and exposed to pesticide. Carriers that may be used in accordance with the present disclosure include oils, including any type of vegetable oil, such as Canola oil, soybean oil and the like, polymers, plastics, wood, gels, colloids, sprays, drenching means, emulsifiable concentrates and so forth. The selection of the carrier and the amount of carrier used in a formulation may vary and depends on several factors including the specific pesticide use and the preferred mode of application. The final pesticide preparation may be formulated as a spray, liquid, dust, fume or powder or in any other form as desired.

Other ingredients that may be used in the formulation of the final product accordance with the present disclosures include mustard bran, and emulsifiers. The mustard bran that may be used may be from the same or from a different species of mustard as the starting mustard plant material that is used. Any additional ingredients that are used in accordance with the present disclosure, in embodiments of the present disclosure where mustard meal is used are preferably co-mixed with the sugar and mustard meal prior to pelletizing of the product.

As hereinbefore mentioned, the present disclosure further provides methods for preparing a pesticide composition comprising (a) providing a material obtainable from a mustard plant comprising an effective amount of a glucosinolate breakdown product and (b) mixing the material obtained from mustard plants with a sugar. In preferred embodiments of the present disclosure mustard seed meal is used to as the material obtained from mustard plants.

### Use of the Pesticide Formulations

The compositions provided herein may be used to control pests. Accordingly, the present disclosure also provides a method for controlling pests comprising applying a composition to a pest comprising (a) a material obtainable from a plant and comprising an effective amount of a glucosinolate breakdown product and (b) a sugar.

The disclosure further provides a method for controlling pests comprising:

(a) preparing a composition comprising:
(i) a material obtainable from a plant and comprising an effective amount of a glucosinolate breakdown product; and
(ii) mixing the material obtained from mustard plants with a sugar; and

(b) applying the composition to a pest.

The pest may be any pest, including any prokaryotic pest, including any prokaryotic pest belonging to the Monera kingdom, and any eukaryotic pest belonging to the Protista, fungal, plant and animal kingdoms. Accordingly pests to which the compositions of the present disclosure may be applied include any insect, arachnid or crustacean pest, including ticks, mites, weevils, ants, mosquitoes etc. Further pests to which the compositions of the present disclosure may be applied are worms and nematodes. As hereinbefore mentioned formulations with different granular sizes may be prepared in accordance with the present disclosure. Granular sizes of 0.01-0.25 mm are particularly suitable for application in fluid suspensions and pesticides applied through irrigation. Granular sizes ranging from 0.25 mm to 0.75 mm are particularly suitable for topical application to surface areas, for example application to turf. Granular sizes from 2 mm to 6 mm are particularly suitable for incorporation in soil and treatment of crops including for example potatoes and strawberries. The delivery route to the pests may vary and may be as desired for example the pesticide product may be delivered as a fumigant, or through aquatic exposure or direct contact. Upon application of the pesticide to the pest, the incidence or severity of the pest infestation or activity will be limited or reduced at least for a limited or more prolonged period of time, and as such the novel methods and compositions disclosed herein provide a means to control pests.

The present disclosure is further described by reference to the following examples which are illustrative only and not limiting the disclosure.

### Example 1

### Preparing Pesticide Formulations Comprising Mustard Plant Material and Sugar and Having Multiple Granular Sizes

One metric ton of mustard seed (Brassica juncea Cutlass) was dried using a Vertec grain dryer, model VT5000 set at a temperature not exceeding 55° C., yielding approximately 980 kg of dried mustard seed having a moisture content of 6.5%. The dried mustard seed was subsequently cleaned using a Damas screen Model 640 ana, yielding approximately 960 kg of seed. The cleaned seed was then subjected to a de-oiling process using a Taby Type 90 oil expeller. The de-oiling process was carried out maintaining a temperature of less than 55° C. and provided seed meal comprising 30% of the total available seed oil content, yielding approximately 672 kg of seed meal. To the de-oiled meal 16 kg of sucrose and 134 kg of Brassica juncea bran was added and the formulation was then mixed using a Munson ribbon blender, model 210 yielding a mixture of approximately 822 kg. The mixture was pelleted using a CPM pellet mill (CPM Master Series) at 50° C. The performance of this process did not result in any substantial yield loss. The pelleted product was thereafter subjected to crumbling using an Apollo roll crumbler, Model 10 having its fluted rolls set at 3 mm-3.5 mm. Again the foregoing process did not result in any substantial yield loss. The crumbled material was then screened using a rotary screen unit (Peacock Industries Inc.) comprising a 10×10×24 gauge load screen and a 4×36×32 finish screen. This yielded three separate fractions: (1) 131 kg of a fraction with granular size of 0.01-0.25 mm; (2) 543 kg of a fraction with a granular size of 0.25 mm-0.75 mm; and (3) 148 kg of a fraction with a granular size of 2 mm-6 mm. Each fraction represents a fully formulated formulation and is ready to be applied as a pesticide.

### Example 2

### Comparison of Pesticide Formulations Comprising Mustard Plant Material Formulated with and without a Sugar

Two Oriental mustard meal containing pesticide formulations were prepared as described in Example 1 above, except that one sample comprised 1% w/w of sucrose and the other sample did not comprise sucrose. The samples were used to evaluate pesticide efficacy against Rhizoctonia solani J. G. Kühn, a seed- or soil-borne pathogen that attacks a very wide range of plant species, causing damping off of seedlings, wire stem, and other blights and rots.

Rhizoctonia solani AG2 stock plate cultures were grown for 10 days on potato dextrose agar plus 0.05% streptomycin added to prevent bacterial growth (streptomycin has no effect on the growth or viability of R. solani). Ninety-six open mouthed, 500 mL Mason jars were covered with aluminium foil to keep them sterile after being removed from the autoclave and autoclaved for 20 minutes at 121° C., then cooled to room temperature. Ninety-six test plates (Petri dishes containing PDA+streptomycin) were made by cutting a fungal plug, approximately 0.5 cm diameter, from one of the stock plates and placing it the centre of the test plate.

Both mustard meal product was assayed at 8 concentrations of per 50 mL water: 0 g (control), 0.025 g, 0.05 g, 0.075, 0.1 g, 0.25 g, 0.5 g, and 1.0 g, with 4 replicates; one jar per replicate. After the appropriate weight of each mustard meal product was added to the jars, 50 mL of sterile distilled water was poured into each jar and the jar was immediately covered with the inverted bottom half of a test plate containing a central plug of R. solani. The joint between the plate and the Mason jar was then wrapped and sealed with a double layer of laboratory parafilm to prevent contamination and drying out of the agar, as well as escape of mustard meal gases. The jars were incubated in the dark at room temperature (21° C.) and radial growth from the edge of the fungal plug was measured in mm at 1, 2, 3, and 5 days, by which time the R. solani mycelium had entirely covered the control plates (40 mm radius).

The data was analyzed statistically (ANOVA) using CoStat, Version 6.400, 2008, CoHort Software, Monterey Calif., USA, © 1998-2008 and means were compared in Tukey's HSD at P=0.05.

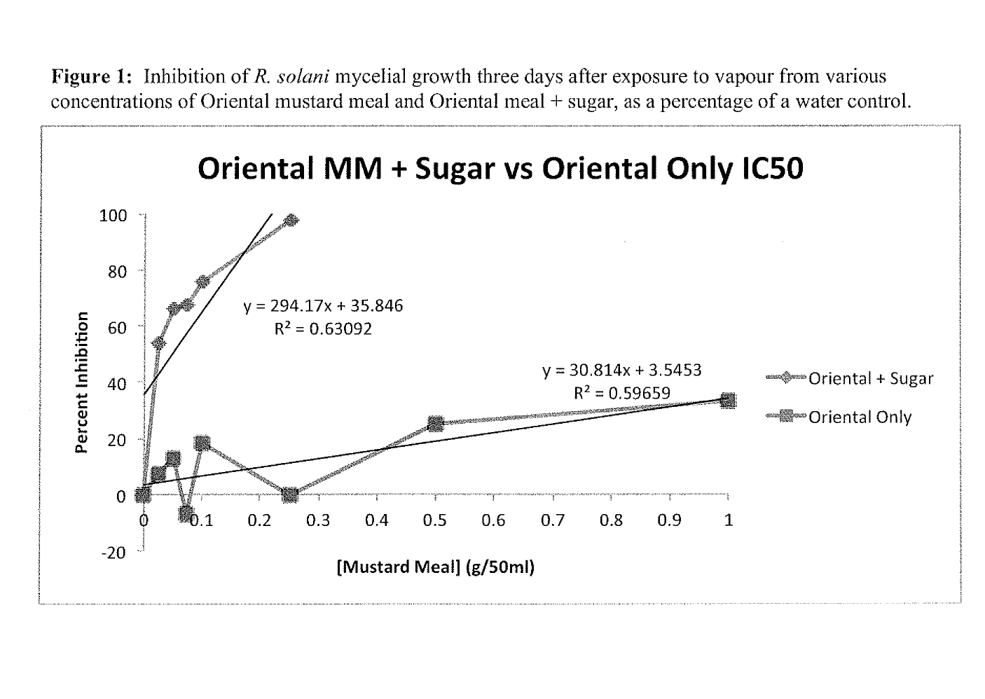

As shown in FIG. 1, R. Solani mycelial growth is inhibited up to approximately 25% after at a concentration of 1 g/50 ml using the Oriental mustard meal sample. Using the Oriental Mustard sample comprising sucrose almost 100% inhibition was attained at a concentration of 0.3 g/50 ml.

As shown in Table 1, in order to achieve 50% inhibition of mycelial growth three days after exposure, a concentration of 1.5076 g/50 ml of Oriental mustard meal sample is required, whereas only 0.0481 g/50 ml of the Oriental mustard comprising sucrose is required. Thus approximately 30× less of the Oriental mustard comprising sucrose is required to achieve a 50% inhibition. Table 1 additionally shows that in order to achieve 90% inhibition of R. Solani mycelial growth 2.8057 g/50 ml and 0.1841 g/50 ml are required using the oriental mustard meal sample and the oriental mustard meal sample comprising sucrose, respectively. Thus approximately 15× less of the Oriental mustard comprising sucrose is required to achieve a 90% inhibition.

Table 2 compares the mean radial growth of R. solani exposed for a period of 5 days to Oriental mustard and Oriental mustard comprising sucrose. As can be seen in Table 2, the mean radial growth of R. solani is substantially less in samples treated with mustard meal comprising sucrose at a concentration of at least 0.05 g/50 ml, indicating a substantial inhibitory effect of the mustard formulation comprising sucrose. No inhibitory effect was observed after five days when the mustard meal sample without sucrose was used.

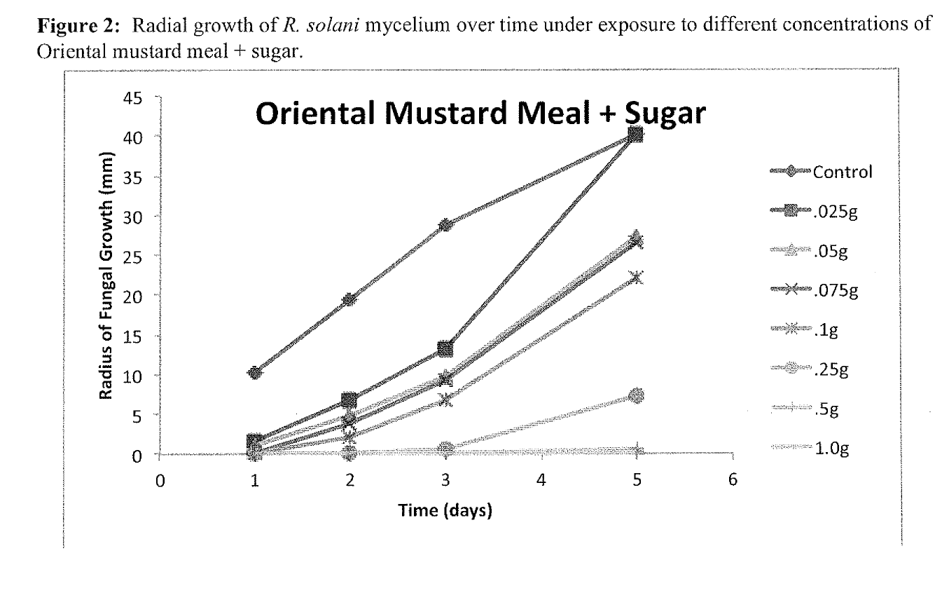

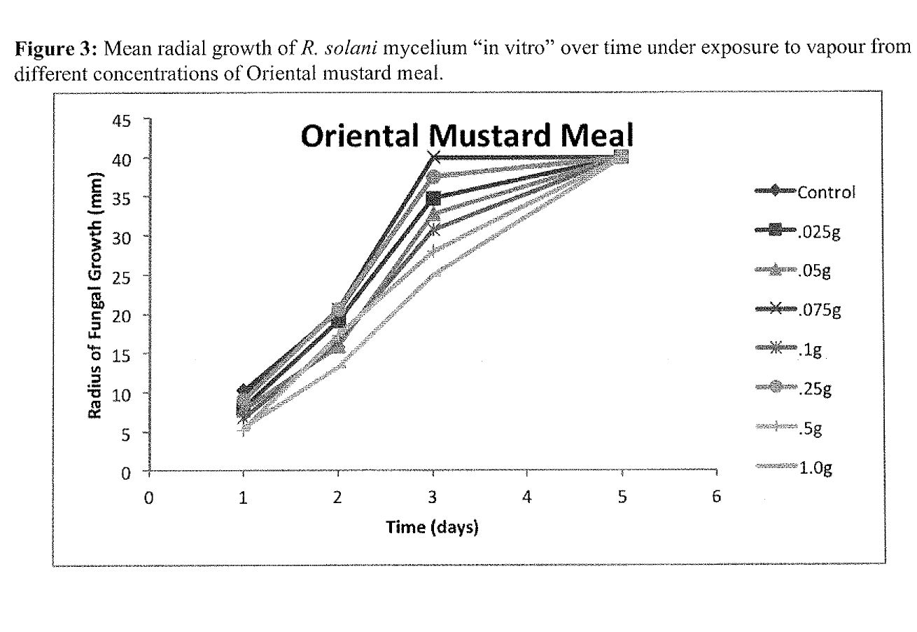

FIGS. 2 and 3 compare the inhibitory effect by determining the mean radial growth of R. solani treated with a formulation comprising Oriental Mustard Meal without sucrose and a formulation Oriental Mustard meal with sucrose as a function of time. As can be seen in FIG. 2 and FIG. 3 a substantial inhibitory effect was observed as a function of time throughout the entire time course at concentrations of at least 0.05 g/50 ml using the sample comprising mustard meal and sucrose. By contrast a small inhibitory effect was observed in the sample comprising Oriental Mustard without sucrose early on in the time course. However the effect was no longer measurable 5 days after exposure.

TABLE 1
Concentration of each activated mustard meal product inhibiting mycelial
growth of Rhizoctonia solani “in vitro” to 50 and 90% of the
water control at three days after exposure.^{1,2}

| | Y = Mycelial | | | | |
|---|---|---|---|---|---|
| Mustard | Growth Rate | | | | |
| Meal | Equation of | IW50 | IC50 | IW90 | IC90 |
| Product | Water Control | (g/50 ml) | (ppm) | (g/50 ml) | (ppm) |
| Oriental | y = | 1.5076 | 30152 | 2.8057 | 56114 |
| Only | 30.814x + 3.5453 | | | | |
| Oriental + | y = | 0.0481 | 962 | 0.1841 | 3682 |
| Sugar | 294.17x + 35.846 | | | | |

¹Mean of 4 replicates per concentration per test product.
²IW = inhibitory weight of mustard meal pellets (g) per 50 mL water; IC = Inhibitory concentration (ppm).

TABLE 2
Mean radial growth of R. solani mycelium “in vitro” at five days after
exposure to vapour from various concentrations of Oriental mustard
meal and Oriental meal + sugar.^{1, 2}

| Day 5 | Oriental + Sugar | | Oriental Only | |
|---|---|---|---|---|
| [C] Mustard | Percent Inhibition | Radial | Percent Inhibition | Radial |
| Meal | (% relative to | Growth | (% relative to | Growth |
| (g/50 ml) | control) | (mm)³ | control) | (mm)³ |
| 0 (Control) | 0 | 40 a | 0 | 40 a |
| 0.025 | 0 | 40 a | 0 | 40 a |
| 0.05 | 31.88 | 27.25 b | 0 | 40 a |
| 0.075 | 34.06 | 26.375 b | 0 | 40 a |
| 0.1 | 45.00 | 22 b | 0 | 40 a |
| 0.25 | 81.88 | 7.25 c | 0 | 40 a |
| 0.5 | 98.44 | 0.625 d | 0 | 40 a |
| 1.0 | 100 | 0 d | 0 | 40 a |

¹Mean of four replicates per concentration per product, RCB design.
²Numbers in both columns followed by the same letter are not significantly different in Tukey's HSD at P = 0.05.
³Radius of 40 mm represents growth to the edge of the plate (i.e., the maximum growth on a media plate).

What is claimed is:

1. A composition for controlling pests comprising (a) a material obtainable from a plant comprising an effective amount of a glucosinolate breakdown product and (b) a sugar.

2. A composition according to claim 1 wherein the plant is a mustard plant.

3. The composition according to claim 2 wherein the material obtainable from the mustard plant is a processed plant material.

4. The composition according to claim 2 wherein the material obtainable from the mustard plant is mustard seed.

5. The composition according to claim 3 wherein the processed mustard plant material is a seed meal.

6. The composition according to claim 1 further comprising a carrier.

7. The composition according to claim 1 wherein the glucosinolate breakdown product is a nitrite, thiocyanate or an isothiocyanate.

8. The composition according to claim 1 wherein the glucosinolate breakdown product is allyl isothiocyate and present in the composition at a concentration of at least 10 μg/mole.

9. The composition according to claim 2 wherein the mustard plant is selected from the group of plants consisting of Brassica napus (rapeseed), Brassica rapa (rapeseed), Brassica juncaea (Indian mustard), Brassica carinata (Abyssinian mustard), Brassica nigra (black mustard), Sinapis alba (white mustard), Sinapis arvensis (wild mustard).

10. The composition according to claim 1 wherein the sugar is a dissacharide or a monosaccharide.

11. The composition according to claim 1 wherein the sugar is selected from the group of sugars consisting of sucrose, fructose, glucose or lactose.

12. The composition according to claim 5 wherein the composition has a granular size selected from the group of granular sizes ranging from 0.01 mm to 0.25 mm; 0.25 mm to 0.75 mm; and 2 mm to 6 mm.

13. A method for preparing a pesticide composition comprising (a) providing a material obtainable from a plant comprising an effective amount of a glucosinolate breakdown product and (b) mixing the material obtained from mustard plants with a sugar.

14. A method for preparing a pesticide composition according to claim 13 comprising (a) providing a material obtainable from a mustard plant comprising an effective amount of a glucosinolate breakdown product, (b) processing the mustard material using a device selected from the group of devices consisting of a pelletizing device, a crumbling device and a screening device, to prepare a pesticide composition, and (c) mixing the processed plant material with a sugar.

15. The method according to claim 13 where in the mustard plant material is mustard seed meal.

16. A method for controlling pests comprising applying a composition to a pest comprising (a) a material obtainable from a plant and comprising an effective amount of a glucosinolate breakdown product and (b) a sugar.

17. A method for controlling pests according to claim 16 comprising (a) preparing a composition comprising:
(i) a material obtainable from a plant and comprising an effective amount of a glucosinolate breakdown product; and
(ii) mixing the material obtained from mustard plants with a sugar; and
(b) applying the composition to a pest.

18. A method according to claim 16 wherein the plant is a mustard plant.
